(19) United States
(12) Patent Application Publication
(10) Pub. No.: US 2026/0330073 A1
(43) Pub. Date: Oct. 22, 2026

(54) GRADING SYSTEM, METHOD, AND PROGRAM

(71) Applicant: ZOZO, Inc., Chiba (JP)

(72) Inventor: Shinji OGAKI, Chiba (JP)

(73) Assignee: ZOZO, Inc., Chiba (JP)

(21) Appl. No.: 19/116,777

(22) PCT Filed: Feb. 6, 2023
(86) PCT No.: PCT/JP2023/003834

§ 371 Date: Mar. 28, 2025

(30) Foreign Application Priority Data
Sep. 30, 2022 (JP) 2022-158548

(51) Int. Cl. G06F 30/10; G06F 30/27; G06F 113/12

(52) U.S. Cl. CPC G06F 30/10; G06F 30/27; G06F 2113/12

(57) ABSTRACT

The invention provides a system for grading, the system comprising: a reception means that receives clothing identification information for identifying target clothing and size information; a generation means that, based on the clothing identification information and the size information, generates pattern paper data of clothing of the same type as the target clothing and having a size suitable for a size indicated by the size information using a trained model, the trained model including a model obtained by learning a relationship between pieces of pattern paper data of a plurality of pieces of clothing of the same type as the target clothing; and an output means that outputs the generated pattern paper data.

### TECHNICAL FIELD

The present invention relates to a system, a method, and a program for grading. The present invention also relates to a clothing manufacturing system, a clothing creation system, a system for generating a trained model for grading, and methods and programs related thereto.

### BACKGROUND ART

Conventionally, a procedural or rule based grading method is known (for example, Patent Document 1). In this method, according to a rule, a shape of a target size is created by combining various functions. In this method, it is possible to control the shape and dimensions of fine parts, but it is very difficult to completely match lengths of sewn portions by hand, and it takes a long time to create pattern paper of one piece of clothing, and it takes a long time to learn the operation of the software implemented by this method. Furthermore, an unintended shape may be formed due to a human error.

### PRIOR ART DOCUMENT

### Patent Document

Patent Document 1: JP-A- 2021-508873

### SUMMARY OF THE INVENTION

### Problems to be Solved by the Invention

As a result of intensive research, the inventor of the present invention has invented a new grading method. In the new grading method, grading is performed using a trained model obtained by learning a relationship between pattern paper data of a plurality of pieces of clothing.

Therefore, the present invention provides, for example, the following items.
(Item 1)

A system for grading, the system including:
reception means that receives clothing identification information for identifying target clothing and size information;
a generation means that, based on the clothing identification information and the size information, generates pattern paper data of clothing of the same type as the target clothing and having a size suitable for a size indicated by the size information using a trained model, the trained model including a model obtained by learning a relationship between pieces of pattern paper data of a plurality of pieces of clothing of the same type as the target clothing; and
an output means that outputs the generated pattern paper data.
(Item 2)

The system according to the above-described item, in which the target clothing and the plurality of pieces of clothing include components whose number varies according to sizes of the target clothing and the plurality of pieces of clothing, and the trained model learns a relationship between pieces of pattern paper data of the plurality of pieces of clothing by aligning the number of the components in the pieces of pattern paper data of the plurality of pieces of clothing.
(Item 3)

The system according to any one of the above-described items, in which the generation means is further configured to delete one or more of the components from the pattern paper data output from the trained model according to the size indicated by the size information.
(Item 4)

The system according to any of the above-described items, in which the components includes at least one of a button, a button-hole, a loop, a tack, a dart or a pleat.
(Item 5)

The system according to any one of the above-described items, further including
a calculation means that calculates reliability of the generated pattern paper data,
in which the output means outputs a notification or does not output the pattern paper data in a case where the reliability is lower than a predetermined threshold.
(Item 6)

The system according to any one of the above-described items, further including a learning means that causes the trained model to learn pattern paper data of clothing having the size in a case where the reliability is lower than the predetermined threshold.
(Item 7)

The system according to any one of the above-described items, in which
the pieces of pattern paper data of the plurality of pieces of clothing do not include a seam allowance, and
the generation means is configured to add a seam allowance to the pattern paper data output from the trained model.
(Item 8)

The system according to any of the above-described items, in which the pattern paper data is represented using a parametric curve.
(Item 8A)

The system according to any one of the above-described items, in which each of the pieces of the pattern paper data of the plurality of pieces of clothing is represented by a plurality of coordinate points, and the trained model learns relationship between the pieces of the pattern paper data of the plurality of pieces of clothing by aligning the number of coordinate points of the pieces of the pattern paper data of the plurality of pieces of clothing.
(Item 9)

A clothing manufacturing system comprising:
the system according to any one of the above-described items; and
means for manufacturing clothing based on the output pattern paper data.
(Item 10)

A clothing creation system, the system including:
a reception means that receives size information;
a generation means that generates, based on the size information, pattern paper data of clothing having a size suitable for a size indicated by the size information using a trained model, the trained model including a model obtained by learning a relationship between pieces of pattern paper data of a plurality of pieces of clothing of a type same as a specific clothing; and
an output means that outputs the generated pattern paper data.
(Item 11)

A method for grading, the method including:
receiving clothing identification information for identifying target clothing and size information;
based on the clothing identification information and the size information, generating pattern paper data of clothing of the same type as the target clothing and having a size suitable for a size indicated by the size information using a trained model, the trained model including a model obtained by learning a relationship between pieces of pattern paper data of a plurality of pieces of clothing of the same type as the target clothing; and
outputting the generated pattern paper data.
(Item 11A)

The method according to item 11, including features according to one or more of the above-described items.
(Item 12)

A program for grading, the program being executed in a computer including a processor, the program causing the processor to perform processing including:
receiving clothing identification information for identifying target clothing and size information;
based on the clothing identification information and the size information, generating pattern paper data of clothing of the same type as the target clothing and having a size suitable for a size indicated by the size information using a trained model, the trained model including a model obtained by learning a relationship between pieces of pattern paper data of a plurality of pieces of clothing of the same type as the target clothing; and
outputting the generated pattern paper data.
(Item 12A)

The program according to item 12, including features according to one or more of the above-described items.
(Item 12B)

A computer-readable storage medium storing the program according to item 12 or 12A.
(Item 13)

A system for generating a trained model for grading, the system including:
a reception means that receives pieces of pattern paper data of a plurality of pieces of clothing, each of the pieces of pattern paper data of the plurality of pieces of clothing being represented by a plurality of coordinate points;
a pre-processing means I that pre-processes the pieces of pattern paper data of the plurality of pieces of clothing, the pre-processing means adding a coordinate point to at least one piece of the pattern paper data of the plurality of pieces of clothing so as to align a number of coordinate points of the pieces of the pattern paper data of the plurality of pieces of clothing; and
a learning means that learns a relationship between the pre-processed pieces of pattern paper data of the plurality of pieces of clothing.
(Item 14)

The system according to any one of the above-described items, in which
the plurality of pieces of clothing includes components whose number varies according to sizes of the plurality of pieces of clothing, and
the pre-processing means adds the component to at least one piece of pattern paper data among the pieces of pattern paper data of the plurality of pieces of clothing so as to align the number of the components in the pieces of pattern paper data of the plurality of pieces of clothing.
(item 15)

The system according to any of the above-described items, in which the pre-processed pieces of pattern paper data of the plurality of pieces of clothing do not include a seam allowance.
(Item 16)

The system according to any one of the above-described items, in which
each of the pieces of pattern paper data of the plurality of pieces of clothing includes dimension information, and
the learning means also learns a relationship between dimensions of the pre-processed pieces of pattern paper data of the plurality of pieces of clothing.
(Item 17)

A method for generating a trained model for grading, the method including:
receiving pieces of pattern paper data of a plurality of pieces of clothing, each of the pieces of pattern paper data of the plurality of pieces of clothing being represented by a plurality of coordinate points;
pre-processing the pieces of pattern paper data of the plurality of pieces of clothing, the pre-processing means adding a coordinate point to at least one piece of the pattern paper data of the plurality of pieces of clothing so as to align a number of coordinate points of the pieces of the pattern paper data of the plurality of pieces of clothing; and
learning a relationship between the pre-processed pieces of pattern paper data of the plurality of pieces of clothing.
(Item 17A)

The method according to item 17, including features according to one or more of the above-described items.
(Item 18)

A program for generating a trained model for grading, the program being executed in a computer including a processor, the program causing the processor unit to perform processing including:
receiving pieces of pattern paper data of a plurality of pieces of clothing, each of the pieces of pattern paper data of the plurality of pieces of clothing being represented by a plurality of coordinate points;
pre-processing the pieces of pattern paper data of the plurality of pieces of clothing, the pre-processing means adding a coordinate point to at least one piece of the pattern paper data of the plurality of pieces of clothing so as to align a number of coordinate points of the pieces of the pattern paper data of the plurality of pieces of clothing; and
learning a relationship between the pre-processed pieces of pattern paper data of the plurality of pieces of clothing.
(Item 18A)

The program according to item 18, including features according to one or more of the above-described items.
(Item 18B)

A computer-readable storage medium storing the program according to item 18 or 18A.

### Advantages of the Invention

According to the present invention, it is possible to provide a system and the like for grading capable of easily obtaining appropriate pattern paper data. Furthermore, according to the present invention, a system and the like for generating a trained model that can be used in such a system for grading can also be provided.

### BRIEF DESCRIPTION OF THE DRAWINGS

FIG. 1A is a diagram schematically illustrating an example of a flow of a service for providing clothing suitable for a user's size.

FIG. 1B is a diagram illustrating an example of a flow of a service for providing desired pattern paper data to a user.

FIG. 2 is a diagram illustrating an example of a configuration of a system 100 for grading.

FIG. 3 is a diagram illustrating an example of a specific configuration of the system 100 for grading.

FIG. 4A is a diagram illustrating an example of a configuration of a processor unit 120.

FIG. 4B is a diagram illustrating an example of a configuration of a processor unit 120A which is an alternative embodiment of the processor unit 120.

FIG. 4C is a diagram illustrating an example of a configuration of a processor unit 120B capable of generating a trained model.

FIG. 5A is a diagram illustrating an example in which a manifold in a latent space generated by learning by a learning means 128 is visualized.

FIG. 5B is a diagram illustrating a concept of aggregating information of a landmark and a coordinate point (normal vertex) between landmarks into each corresponding extended vertex.

FIG. 6A is a flowchart illustrating an example (a process 600) of a process for grading by the system 100 for grading.

FIG. 6B is a flowchart illustrating another example (a process 610) of a process for grading by the system 100 for grading.

FIG. 7 is a flowchart illustrating another example (a process 700) of a process for generating a trained model by the system 100 for grading.

### MODE FOR CARRYING OUT THE INVENTION

### 1. Definitions

In the present specification, a “target clothing” refers to clothing to be graded. By performing the grading, the pattern paper data of the clothing of the same type as the target clothing and having a size different from that of the target clothing is obtained.

In the present specification, the “clothing of the same type” refers to clothing having at least the same type, and the type is represented by a model number, a product number, a model type, a model, or the like.

### In the Present Specification, the “topology” of the Pattern

paper refers to a structure of a graph formed by vertexes and line segments forming the pattern paper. Two sheets of pattern paper having the same topology refers to a state in which the same number of points exist in the shapes of the two sheets of pattern paper, and the points are connected by a line segment or a curve in the same manner.

In the present specification, the clothing may or may not include components such as buttons, button-holes, loops, tacks, darts, or pleats. In a case where the clothing includes such components, the number of the components may vary depending on the size, or may be the same in clothing of the same type. For example, larger sized pieces of clothing may have more components and smaller sized pieces of clothing may have fewer components.

### 2. Service for Providing Clothing Suitable for User's Size

The inventor of the present invention has developed a system for grading to which a new grading method has been applied. According to the system for grading, a user can obtain various sizes of pattern paper data of pieces of clothing by designating the clothing to be graded. For example, when clothing to be graded is designated and a desired size is designated, it is possible to obtain pattern paper data capable of manufacturing clothing of the desired size. This makes it possible, for example, to provide clothing of a personalized size to the user.

In conventional manual grading, it is difficult to obtain appropriate pattern paper data. This is because it is very difficult to completely match the lengths of the sewn portions by hand. According to the system for grading, appropriate pattern paper data can be easily obtained. Here, the appropriate pattern paper data refers to pattern paper data capable of manufacturing clothing, and being capable of manufacturing clothing refers to at least (1) that all components necessary for manufacturing the clothing are present, (2) that the lengths of portions to be coupled (for example, portions to be sewn, portions to be joined with an adhesive, and the like) are matched or the length deviation of the portions to be coupled is within an allowable range, and (3) that the shape of the clothing is correct in a case where the portions to be coupled are coupled. For example, in the case of clothing manufactured by cutting with a round blade, a straight blade cutting machine, or the like and sewing with a sewing machine, being capable of manufacturing means that, in addition to the above-described (1) to (3), (4) each component is not too small, does not include an extremely thin place that is easily torn off, and can be cut from a flat fabric, and (5) each component has a sufficient seam allowance between a contour line (also referred to as a finishing line) of the pattern paper and a line for cutting (referred to as a cutting line), and can be joined (for example, hand sewing or sewing machine sewing) with other components.

In one example, by using the system for grading, for example, a service for providing clothing suitable for the size of the user can be realized.

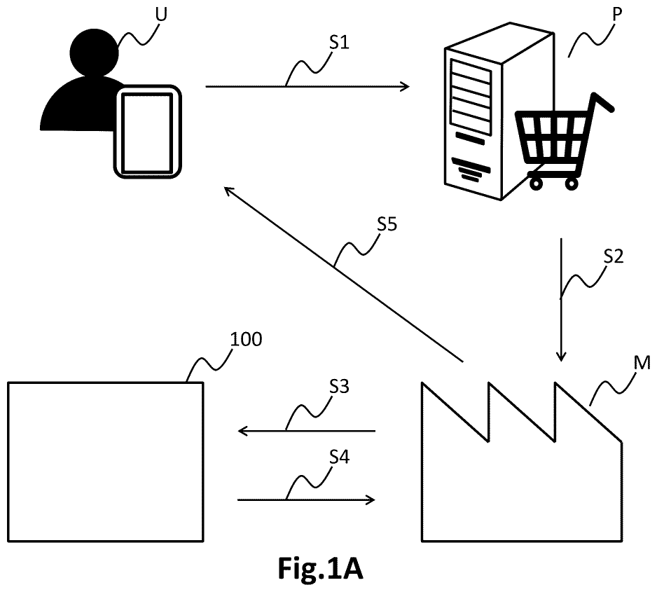

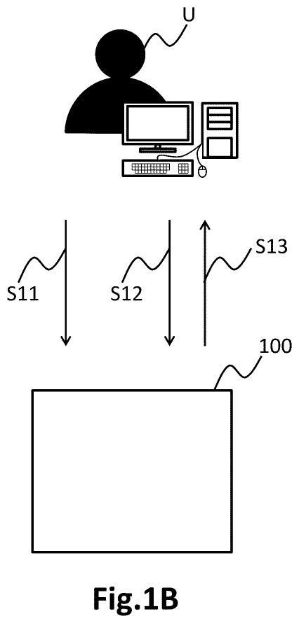

FIG. 1A schematically illustrates an example of a flow of a service for providing clothing suitable for a user's size. In the example illustrated in FIG. 1A, an example in which a user U who is a general consumer purchases clothing via an EC site provided by a provider P will be described.

In step S1, the user U accesses the EC site provided by the provider P via a terminal device (for example, a smartphone). In the EC site, clothing is sold. When the user U finds desired clothing on the EC site, the user U inputs a size, inputs necessary personal information, and the like, and performs payment. Here, the size of the user U is not a standard size such as S, M, or L, but may be a specific size of the user U. A specific size of the user U may be, for example, a size of a body (for example, a height, a weight, a chest circumference, a waist circumference, and a hip circumference) or a size of clothing (for example, length (more specifically, for example, a skirt length, a pants length, a sleeve length, a rise length, an inseam length, a dress length, and sleeves), a width (more specifically, a shoulder width, a body width, a chest circumference, a waist, a hip, a thigh circumference, a hem circumference, a knee width, and the like), component dimensions (for example, a pocket opening dimension, a fastener dimension, and the like.)). The size of the clothing is preferably a size that is easy for the user to memorize or to imagine the body shape, and may be a size that is easy for the user to determine the outer shape of the clothing (for example, a dress length and a body width, a pants length or a skirt length, a waist, and the like.).

When the payment is completed, the purchased clothing is provided to the user U, but in the present example, it is assumed that there is no stock of the purchased clothing. That is, it is assumed that the clothing needs to be manufactured in order to provide the purchased clothing to the user U. Of course, in a case where there is stock, the provider P can provide the stock clothing to the user U.

In step S2, a manufacturing request is made from the provider P to a manufacturer M. In this case, the provider P and the manufacturer M may be different companies or the same company (for example, the provider P is a sales department and the manufacturer M is a manufacturing department.). The provider P passes the model number of the clothing to be manufactured and size information indicating the size to the manufacturer M. Thus, the manufacturer M manufactures the clothing identified by the model number in the size indicated by the size information.

When the manufacturer M has the pattern paper data of the clothing, the manufacturer M can manufacture the clothing according to the pattern paper data. However, since the size input by the user U is not a standard size such as S, M, or L, but may be a specific size of the user U, the manufacturer M may not have the pattern paper data. In this case, the manufacturer M can obtain the pattern paper data capable of manufacturing the clothing having the size input by the user U by using the system 100 for grading.

In step S3, the manufacturer M passes the model number and the size information to the system 100 for grading. The system 100 for grading generates, based on the model number and the size information, pattern paper data for clothing identified by the model number and having a size indicated by the size information.

In step S4, the system 100 for grading provides the generated pattern paper data to the manufacturer M. With this pattern paper data, the manufacturer can manufacture the clothing identified by the model number in the size indicated by the size information.

In step S5, the manufactured clothing is provided to the user U. The manufactured clothing may be provided to the user U directly from the manufacturer M, may be provided to the provider P and provided to the user U from the provider P, or may be provided to the user U following other paths, for example.

In this way, the user U can obtain desired clothing and clothing whose size matches his/her body shape.

For example, even if the manufacturer M prepares as many as 25 pieces of pattern paper in total of 5 lengths×5 widths, the user U may want to finely adjust the length and the width according to his/her body shape, and even 25 pieces of pattern paper data may not be able to meet the request of the user U. In this case, since the system 100 can create the pattern paper data according to the size of the user U on the fly, it is possible to meet the request of the user U and do not press a storage with lots of pieces of pattern paper data.

Note that, in the above-described example, it has been described that the user U inputs his/her specific size, but the mode of input of the size is not limited thereto. For example, a size measured by a size measurement system (for example, a system capable of measuring the size of a body by a user wearing a dedicated suit and imaging the user's appearance (WO 2019/189846 A or the like) ) may be input.

In another example, by using a system for grading, for example, a service for providing desired pattern paper data to a user can be realized.

FIG. 1B illustrates an example of a flow of a service for providing desired pattern paper data to a user. In the example illustrated in FIG. 1B, an example in which a user U who is a clothing manufacturer manufactures a plurality of pieces of clothing of various sizes with the same design will be described. In order to create the plurality of pieces of clothing having the same design and various sizes, the user U needs pattern paper data according to the sizes.

In step S11, the user U inputs a plurality of pieces of pattern paper data to the system 100 for grading via a terminal device (for example, a personal computer). Here, the plurality of pieces of pattern paper data is pieces of pattern paper data of a plurality of pieces of clothing having the same design and different sizes. The plurality of pieces of pattern paper data is pieces of pattern paper data capable of manufacturing clothing. The system 100 for grading will learn a relationship between these plurality of pieces of pattern paper data.

In step S12, the user U inputs the size information to the system 100 for grading via the terminal device. Then, the system 100 for grading generates pattern paper data of clothing having the same design and the size indicated by the size information.

In step S13, the system 100 for grading provides the user U with the generated pattern paper data. With this pattern paper data, the user U can manufacture clothing having the same design and the size indicated by the size information.

The user U can obtain pieces of pattern paper data of a plurality of pieces of clothing having the same design and various sizes by varying the size input in step S12 and repeating steps S12 and S13. As a result, the user U can manufacture the plurality of pieces of clothing having the same design and various sizes.

For example, the user U can reduce the operation cost by using the system 100 for grading. For example, when it is desired to prepare 20 pieces of pattern paper data of different sizes, by, for example, creating only 10 pieces of pattern paper data and inputting the pattern paper data of the 10 pieces of pattern paper to the system 100 in step S11, the user U can cause the system 100 to generate remaining 10 pieces of pattern paper data. As a result, the work of the user U can be halved.

The system 100 for grading described above may, for example, have the configuration described below.

### 3. Configuration of System for Grading

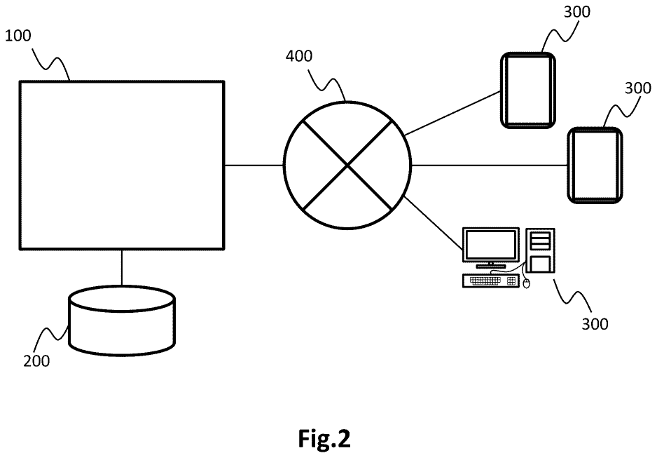

FIG. 2 illustrates an example of a configuration of the system 100 for grading. The system 100 is connected to a database unit 200. Furthermore, the system 100 is connected to at least one terminal device 300 via a network 400.

Note that, in FIG. 2, three terminal devices 300 are illustrated, but the number of terminal devices 300 is not limited thereto. Any number of terminal devices 300 may be connected to the system 100 via the network 400.

The network 400 can be any type of network. The network 400 may be, for example, the Internet or a LAN. The network 400 may be a wired network or a wireless network.

An example of the system 100 is, but is not limited to, a computer (for example, a server device) installed in a provider that provides a service of providing clothing that matches a user's size. The system 100 may be, for example, a computer (for example, the terminal device) installed at a clothing manufacturer. In this case, the system 100 may not be connected to the network 400. The terminal device may be any type of terminal device such as a smartphone, a tablet, a personal computer, smart glasses, a smart watch, or the like.

The database unit 200 stores pattern paper data created by a patterner or a grader, which can be used to generate a trained model. The database unit 200 can store the pattern paper data generated by the system 100 and/or the trained model generated by the system 100.

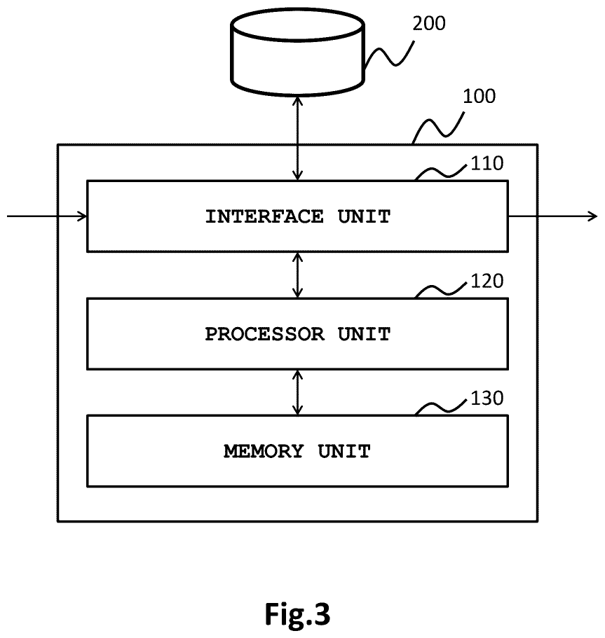

FIG. 3 illustrates an example of a specific configuration of the system 100 for grading.

The system 100 includes an interface unit 110, a processor unit 120, and a memory unit 130.

The interface unit 110 exchanges information with the outside of the system 100. The processor unit 120 of the system 100 can receive information from the outside of the system 100, and can transmit information to the outside of the system 100 via the interface unit 110 The interface unit 110 can exchange the information in an arbitrary format.

The interface unit 110 includes, for example, an input unit that enables information to be input to the system 100. It does not matter how the input unit enables information to be input to the system 100. For example, in a case where the input unit is a touch panel, the user may input information by touching the touch panel. Alternatively, in a case where the input unit is a mouse, the user may input information by operating the mouse. Alternatively, in a case where the input unit is a keyboard, the user may input information by pressing a key of the keyboard. Alternatively, in a case where the input unit is a microphone, the user may input information by inputting a voice into the microphone. Alternatively, in a case where the input unit is a data reading device, information may be input by reading information from a storage medium connected to the system 100. Alternatively, in a case where the input unit is a receiver, the input unit may receive information from the outside of the system 100 via a network. In this case, the type of the network is not limited. For example, the receiver may receive information via the Internet or may receive information via a LAN.

The interface unit 110 includes, for example, an output unit that enables information to be output from the system 100. It does not matter how the output unit enables information to be output from the system 100. For example, in a case where the output unit is a display screen, information may be output to the display screen. Alternatively, in a case where the output unit is a data writing device, information may be output by writing the information in a storage medium connected to the system 100. Alternatively, in a case where the output unit is a printing device, information may be output by printing on a medium such as paper. Alternatively, in a case where the output unit is a transmitter, the transmitter may transmit information to the outside of the system 100 via a network to output the information. In this case, the type of the network is not limited. For example, the transmitter may transmit information via the Internet or may transmit information via a LAN.

The system 100 can, for example, transmit information to the database unit 200 and/or receive information from the database unit 200 via the interface unit 110. The system 100 can, for example, transmit information to the terminal device 300 and/or receive information from the terminal device 300 via the interface unit 110.

The system 100 may receive, for example, clothing identification information identifying the target clothing and size information via the interface unit 110. The system 100 can receive, for example, pieces of pattern paper data of a plurality of pieces of clothing via the interface unit 110.

The system 100 may, for example, output graded pattern paper data via the interface unit 110. The system 100 can, for example, output the generated trained model via the interface unit 110.

The processor unit 120 executes processing of the system 100 and controls the operation of the entire system 100. The processor unit 120 reads a program stored in the memory unit 130 and executes the program. This enables the system 100 to function as a system that performs desired steps. The processor unit 120 may be implemented by a single processor or may be implemented by a plurality of processors.

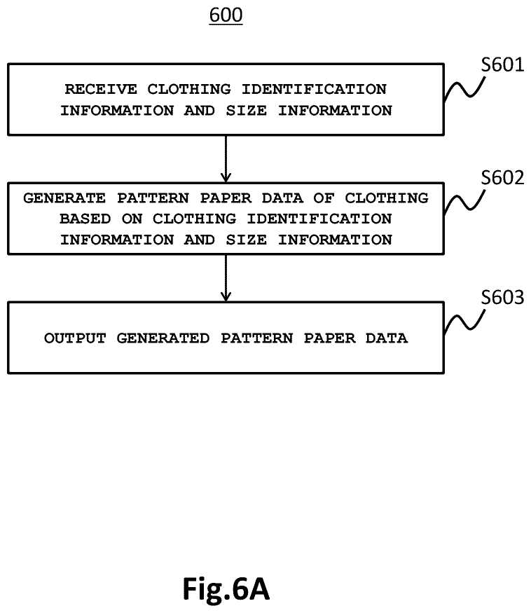

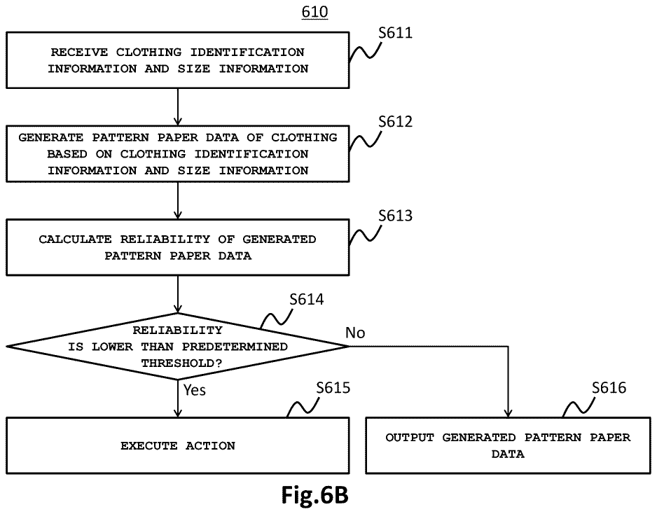

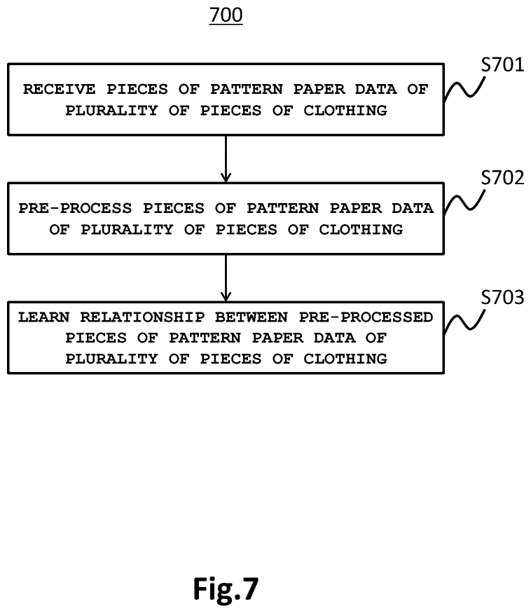

The memory unit 130 stores a program required for executing processing of the system 100, data required for executing the program, and the like. The memory unit 130 may store a program (for example, a program for realizing a process illustrated in FIG. 6A or 6B described later) for causing the processor unit 120 to perform a process for grading and/or a program (for example, a program for realizing a process illustrated in FIG. 7 to be described later) for causing the processor unit 120 to perform a process for generating a trained model for grading. Here, how to store the program in the memory unit 130 does not matter. For example, the program may be pre-installed in the memory unit 130. Alternatively, the program may be installed in the memory unit 130 by being downloaded via a network. In this case, the type of the network is not limited. The memory unit 130 can be implemented by an arbitrary storage means.

The database unit 200 can store, for example, pattern paper data as learning data. Furthermore, the database unit 200 can store pattern paper data generated by the system 100 and/or a trained model generated by the system 100.

In the example illustrated in FIG. 3, the database unit 200 is provided outside the system 100, but the present invention is not limited thereto. The database unit 200 can also be provided inside the system 100. In this case, the database unit 200 may be implemented by the same storage means as the storage means that implements the memory unit 130, or may be implemented by a storage means different from the storage means that implements the memory unit 130. In any case, the database unit 200 is configured as a storage unit for the system 100. The configuration of the database unit 200 is not limited to a specific hardware configuration. For example, the database unit 200 may be configured by a single hardware component or may be configured by a plurality of hardware components. For example, the database unit 200 may be configured as an external hard disk device of the system 100, or may be configured as a storage on a cloud connected via a network.

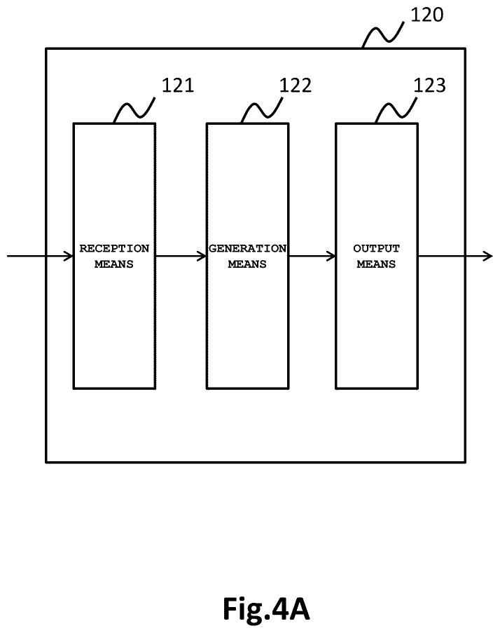

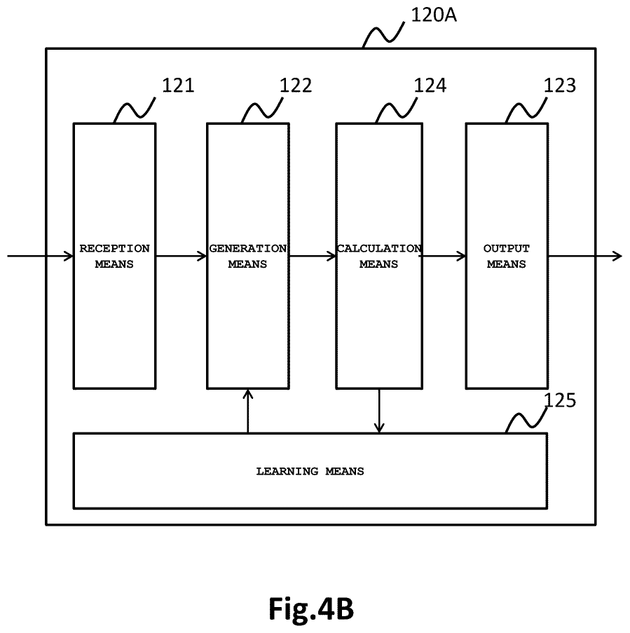

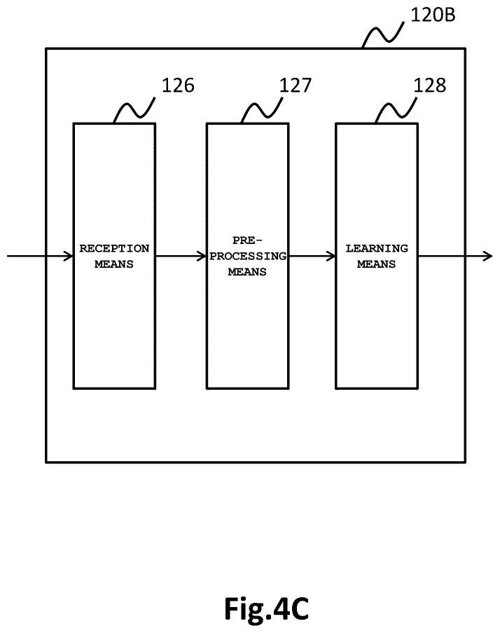

FIG. 4A illustrates an example of a configuration of the processor unit 120.

The processor unit 120 includes a reception means 121, a generation means 122, and an output means 123.

The reception means 121 is configured to receive clothing identification information for identifying the target clothing and size information.

The clothing identification information may be any information as long as the target clothing can be identified. For example, the clothing identification information may be information indicating a type of clothing (for example, a model number, a product number, a model type, a model, and the like.). For example, the clothing identification information may be image data of the target clothing or pattern paper data of the target clothing.

The size indicated by the size information may be the size of a body of a wearer of the clothing (for example, a user who is a general consumer), may be the size of the desired clothing, or may be the size of the pattern paper for making the desired clothing. Therefore, the size information may indicate, for example, a size of a body (for example, a height, a weight, a chest circumference, a waist circumference, and a hip circumference), a size of clothing (for example, a length, a width), or a size of pattern paper.

The generation means 122 is configured to generate, based on the clothing identification information and the size information, the pattern paper data of the clothing of the same type as the target clothing and having a size suitable for the size indicated by the size information. The generation means 122 can generate the pattern paper data of the clothing of the same type as the target clothing using the trained model. The trained model is a model obtained by learning a relationship between a plurality of pieces of pattern paper data of the clothing of the same type as the target clothing.

The generation means 122 can use one trained model among the plurality of trained models. In this case, the generation means 122 can select the trained model corresponding to the target clothing indicated by the clothing identification information from among the plurality of trained models. In a case where there is no trained model that learns the relationship between the plurality of pieces of pattern paper data of the clothing of the same type as the target clothing among the plurality of trained models, the generation means 122 may generate the trained model by processing by the processor unit 120B described later.

Each of the plurality of pieces of pattern paper data used for learning can be expressed by a plurality of coordinate points. That is, the plurality of pieces of pattern paper data may be vector data. The trained model learns a plurality of coordinate points as feature amounts. In one example, at least some of the coordinate points can be control points of a parametric curve. In this case, the pattern paper data is expressed using a parametric curve (for example, a Bezier curve or a B-spline curve). It is advantageous in that the amount of data can be reduced to express the pattern paper data by the parametric curve. For example, in a case where the pattern paper data represented by 20 coordinate points is represented by a cubic Bezier curve, the pattern paper data can be represented by four control points, and the data amount can be reduced to ⅕. By reducing the data amount, it is possible to reduce the time required for learning the pattern paper data and the time required for generating the pattern paper data, and it is also possible to reduce the memory usage.

The trained model can be created by unsupervised learning. The trained model may be generated using, for example, a Gaussian process latent variable model (GPLVM), or the trained model may be generated using, for example, an Auto Encoder, or the trained model may be generated using another method capable of learning a relationship between learning data.

For example, in a case where the GPLVM is used, a manifold can be formed in a latent space by learning.

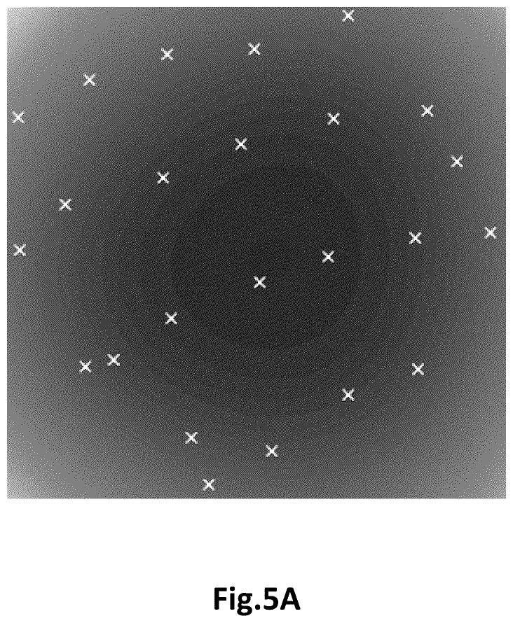

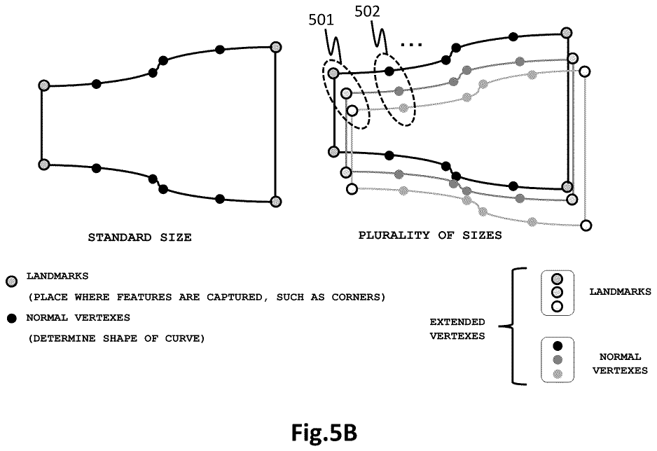

FIG. 5A illustrates an example of a manifold formed by learning using the GPLVM. In FIG. 5A, points represented by x in a latent space represent respective pieces of learning data. Any point in the latent space will represent the corresponding pattern paper data. That is, the first point in the latent space corresponds to pattern paper data having the first size, and the second point in the latent space corresponds to pattern paper data having the second size. In order to generate the pattern paper data having the size indicated by the size information, the generation means 122 searches the latent space for the pattern paper data having the size indicated by the size information.

In FIG. 5A, gradation of density represents reliability of the pattern paper data. This indicates that the reliability of the pattern paper data corresponding to the points in a dark area is high, and the reliability of the pattern paper data corresponding to the points in a light area is low. That is, the pattern paper data corresponding to the points near the center has higher reliability than the pattern paper data corresponding to the points near the four corners. Here, the reliability is an index indicating whether or not appropriate pattern paper data is obtained. When the reliability is low, it cannot be said to be appropriate pattern paper data, and it may be impossible to manufacture clothing from the pattern paper data.

By using the plurality of pieces of pattern paper data used for learning as the pattern paper data of the clothing that can be manufactured, the generated manifold can be a set of points representing the pattern paper data with high reliability, and there is a high possibility that the pattern paper data generated by the generation means 122 is the pattern paper data of the clothing that can be manufactured.

In one embodiment, the clothing may include components that vary in number depending on size. The component includes at least one of a button, a button-hole, a loop, a tack, a dart, or a pleat. For example, larger sized pieces of clothing have more components and smaller sized pieces of clothing have fewer components. In this case, the pattern paper data used for learning also represents the number of components and respective positions. In the trained model, the number and positions of components in the pieces of pattern paper data of a plurality of pieces of clothing are also learned as feature amounts.

In a case where the number of components is different in each of the plurality of pieces of pattern paper data used for learning, the number of coordinate points is also different in each of the plurality of pieces of pattern paper data used for learning. In this case, learning may fail or an appropriate output may not be obtained from the trained model. In the trained model used by the generation means 122 of the system 100, it is preferable that the number of components is made uniform in each of the plurality of pieces of pattern paper data used for learning, and the relationship between the pieces of pattern paper data of the plurality of pieces of clothing is learned. Aligning the number of components in each of the plurality of pieces of pattern paper data used for learning is achieved, for example, by matching the number of components of the pattern paper data having the largest number of components among the plurality of pieces of pattern paper data with the number of components of the other pieces of pattern paper data. In order to match the number of components, for example, a virtual component (also referred to as a phantom) can be generated and added to the pattern paper data.

For example, it is assumed that the maximum value of the number of buttons in the plurality of pieces of pattern paper data is eight, and the number of buttons included in certain pattern paper data is six. In this case, 8−6=2 phantoms (virtual buttons) are generated in the pattern paper data. In this way, the number of buttons included in each piece of pattern paper data can be forcibly unified to eight, and the topology of all pieces of pattern paper data can be made the same. By performing similar processing on button-holes, loops, and the like other than the buttons, the respective numbers can be made uniform.

It is possible to improve the possibility of successful learning and to increase the possibility of obtaining an appropriate output from the trained model by performing learning with the number of components being aligned in each of the plurality of pieces of pattern paper data used for learning. However, there is a case where the pattern paper data output from the trained model includes a larger number of components than the originally intended number. In particular, in a case where pattern paper data of a small size is output, it is possible to include more components than the number of components that should originally be included. Therefore, the generation means 122 can delete one or more components from the pattern paper data output from the trained model according to the size, so that the pattern paper data can have the number of components that should originally have.

As described above, since the trained model also learns the number of components in the pieces of pattern paper data of the plurality of pieces of clothing as the feature amount, the pattern paper data output from the trained model also includes an estimated value of the number of components. The generation means 122 rounds up or rounds down a fraction of the estimated value of the number of components included in the pattern paper data to obtain an integer value, and this integer value can be regarded as the number of components that the pattern paper data should originally have. The generation means 122 compares the integer value with the number of components included in the pattern paper data output from the trained model, and can delete one or more components from the pattern paper data output from the trained model such that the number of components included in the pattern paper data output from the trained model becomes the integer value.

In this way, the possibility of successful learning is improved, the possibility of obtaining an appropriate output from the trained model is also increased, the number of components of the pattern paper data generated by the generation means 122 can be made appropriate, and generation of practical pattern paper data can be achieved.

In one embodiment, the pattern paper data used for learning can also include dimensions of each part, and the trained model can learn dimensions of each part in the pieces of pattern paper data of a plurality of pieces of clothing as feature amounts. As a result, the pattern paper data output from the trained model also includes the estimated value of the dimension of each part. This may facilitate searching within the latent space of the pattern paper data having the size indicated by the size information.

In one embodiment, the pattern paper data used for learning preferably does not include a margin called a seam allowance. The seam allowance is not a smooth curve, but may have a distorted shape, which is likely to cause a problem in learning. Moreover, the output from the trained model may also be unstable.

Since the pattern paper data used for learning does not include the seam allowance, the pattern paper data output from the trained model also does not include the seam allowance. Therefore, the generation means 122 can add a seam allowance to the pattern paper data output from the trained model.

In one example, the generation means 122 converts the pattern paper data output from the trained model into an image, obtains a signed distance function by an image processing-based method, specifies a line equidistant outside from an outline of the pattern paper, and can set a region between the outline and the line as a seam allowance. By converting the image of the seam allowance into vector data, it is possible to obtain pattern paper data to which the seam allowance is added.

For example, in a case where the pattern paper data has an acute-angle notched portion such as a dart, when the above-described method is performed as it is, there is a case where it is not successful. Therefore, in a case where the pattern paper data has an acute-angle notched portion such as a dart, it is preferable to perform the above-described method after deleting the notched portion. Accordingly, the seam allowance can be appropriately added.

For example, in a case where the pattern paper data partially has an acute angle, the seam allowance of the acute angle may be greatly separated from the outline of the pattern paper. In this case, waste of the fabric may be avoided by cutting off a portion greatly away from the outline of the pattern paper.

For example, the generation means 122 can generate the pattern paper data by deleting a specific component (for example, a pocket, a collar, or the like) included in the pattern paper data output from the trained model. As a result, it is possible to generate pattern paper data for manufacturing clothing of various variations such as variations depending on the presence or absence of pockets and variations depending on the presence or absence of collars.

The output means 123 is configured to output the generated pattern paper data. The output means 123 can output the generated pattern paper data to the outside of the system 100 via the interface unit 110. The output means 123 can output the generated pattern paper data to the database unit 200 via the interface unit 110, for example. The output means 123 can output the generated pattern paper data to the terminal device 300 via the interface unit 110, for example.

The output pattern paper data can be used for any purpose. For example, as described above with reference to FIG. 1A, it may be provided to the manufacturer M and utilized to manufacture clothing purchased by the user U. For example, as described above with reference to FIG. 1B, it may be provided to the user U and utilized to manufacture clothing having a variety of sizes.

FIG. 4B illustrates an example of a configuration of a processor unit 120A which is an alternative embodiment of the processor unit 120. In FIG. 4B, the same configuration elements as those described with reference to FIG. 4A are denoted by the same reference signs, and detailed description is omitted here.

The processor unit 120A includes a reception means 121, a generation means 122, a calculation means 124, and an output means 123.

The pattern paper data generated by the generation means 122 is passed to the calculation means 124.

The calculation means 124 is configured to calculate the reliability of the generated pattern paper data.

In one example, the calculation means 124 can calculate the reliability based on the position of the generated pattern paper data in the latent space. As described above, by learning the relationship between the pieces of pattern paper data, it is possible to form a manifold in the latent space. An arbitrary point in the latent space represents corresponding pattern paper data, and each pattern paper data has reliability according to a position in the latent space. Therefore, the calculation means 124 can calculate the reliability corresponding to the position by specifying the position of the generated pattern paper data in the latent space.

In another example, when the trained model also learns the reliability of the plurality of pieces of pattern paper data, the calculation means 124 can calculate the reliability based on the output from the trained model. This is because the trained model also learns the reliability of the plurality of pieces of pattern paper data, so that the trained model can also output an estimated value of the reliability of the output pattern paper data.

Means by which the calculation means 124 calculates the reliability is not limited to the method of the above-described example, and the calculation means 124 can calculate the reliability also by another method.

The output means 123 can perform a given action depending on the calculated reliability.

In one example, the output means 123 may be configured not to output the generated pattern paper data in a case where the reliability of the generated pattern paper data is lower than a predetermined threshold. As a result, it is possible to prevent the low reliability pattern paper data from being provided to the user. Not outputting the generated pattern paper data may be notified to the user, for example, as in an example described later.

In another example, the output means 123 can output the notification in a case where the reliability of the generated pattern paper data is lower than a predetermined threshold. The notification may be, for example, a notification indicating that the reliability of the generated pattern paper data is low, or a notification for confirming to the user that the pattern paper data is output, even though the reliability of the generated pattern paper data is low. Alternatively, the notification may be a notification indicating that the pattern paper data is not output because the reliability of the generated pattern paper data is low. This notification allows the user or the administrator of the system 100 to take steps to improve reliability. The measure includes, for example, creation and learning of new learning data corresponding to the pattern paper data, or modification of existing learning data. For example, creation of new learning data and correction of existing learning data are performed by a patterned or grader, and the created new learning data and the corrected existing learning data can be highly reliable pattern paper data.

In an embodiment in which new learning data is created or existing learning data is corrected, the processor unit 120A can further include a learning means 125.

In a case where the reliability calculated by the calculation means 124 is lower than a predetermined threshold value, the learning means 125 can cause the trained model to relearn the pattern paper data of the clothing having the corresponding size so that pattern paper data with high reliability can be output instead of the pattern paper data.

Specifically, the generation means 122 generates the pattern paper data having the first size, the calculation means 124 calculates the reliability of the pattern paper data having the first size, and in a case where the calculated reliability is lower than a predetermined threshold, the learning means 125 causes the trained model to learn the pattern paper data for learning having the first size. As a result, the trained model no longer outputs the pattern paper data with low reliability as the pattern paper data having the first size and instead outputs the retrained pattern paper data. In this case, the reliability of the pattern paper data output from the trained model should be high.

In this way, when the reliability is low, by repeating relearning using new learning data or corrected learning data, the manifold in the latent space converges to an ideal one. Such relearning is advantageous in that the trained model can be refined in the operation phase.

FIG. 4C illustrates an example of a configuration of the processor unit 120B capable of generating a trained model.

The processor unit 120B includes a reception means 126, a pre-processing means 127, and a learning means 128.

The reception means 126 is configured to receive pattern paper data of a plurality of pieces of clothing. The pattern paper data of the plurality of pieces of clothing is learning data. Each of the pattern paper data of the plurality of pieces of clothing can be represented by a plurality of coordinate points and can be vector data. In one example, at least some of the coordinate points can be control points of a parametric curve. In this case, the pattern paper data is expressed using a parametric curve (for example, a Bezier curve or a B-spline curve). It is advantageous, in that the amount of data can be reduced to express the pattern paper data by the parametric curve. For example, in a case where the pattern paper data represented by 20 coordinate points is represented by a cubic Bezier curve, the pattern paper data can be represented by four control points, and the data amount can be reduced to ⅕. By reducing the amount of data, it is possible to reduce the time required for learning the pattern paper data, and it is also possible to reduce the memory usage.

It is particularly preferable that the pattern paper data of the plurality of pieces of clothing received by the reception means 126 is pattern paper data of clothing that can be manufactured. This is because the pattern paper data output from the trained model can be the pattern paper data of the clothing that can be manufactured by generating the trained model using the pattern paper data of the clothing that can be manufactured.

The pattern paper data of the plurality of pieces of clothing received by the reception means 126 may be pattern paper data of the pieces of clothing that are of the same type as a specific clothing item and have different sizes. As a result, the generated trained model can generate pattern paper data of clothing of the same type as the specific clothing and having a size suitable for the specific size and thus can be used for grading of the specific clothing.

In another example, the pattern paper data of the plurality of pieces of clothing received by the reception means 126 may be pattern paper data of pieces of clothing each having the same topology as the specific clothing and having different sizes and/or shapes, and does not necessarily need to be the clothing of the same type as the specific clothing. This allows the generated trained model to generate pattern paper data for clothing that has a different size and/or shape than the particular clothing, thus making it available for the creation of new clothing.

For example, in the case of a plurality of pieces of pattern paper data (for example, pattern paper data in which how the fabric is attached to the belt portion and where the pocket and tack are inserted are the same and the zip is also common) of the pants having the same topology, the pattern paper data of the shape in which the hem is widened like the bell bottom and the pattern paper data of the shape such as the ultra slim-pants can be handled in the same manner, and the trained model generated from the plurality of pieces of pattern paper data can generate, for example, an intermediate shape between the bell bottom and the ultra slim-pants, and can also generate a shape in which the bell bottom is extrapolated so as to further widen the hem.

The pattern paper data of the plurality of pieces of clothing received by the reception means 126 can also include dimensions of each part.

The plurality of pieces of pattern paper data received by the reception means 126 is passed to the pre processing means 127.

The pre-processing means 127 is configured to pre-process the pattern paper data of the plurality of pieces of clothing received by the reception means 126.

The pre-processing is performed, for example, to reduce errors in learning and/or to enable learning to be performed efficiently.

For example, the pre-processing means 127 inspects whether an error is included in the plurality of pieces of received pattern paper data. For example, the pre-processing means 127 inspects whether there is a zigzag shape in the outline. The zigzag shape is difficult to visually confirm, and may interfere with the learning of pattern paper data, and may cause a problem even in cutting the fabric based on the generated pattern paper data. For example, the pre processing means 127 checks whether the number of buttons and the number of button-holes are aligned, and if not, whether the buttons are decorative buttons. In a case where an error is confirmed, the pre-processing means 127 may notify that it is necessary to correct the pattern paper data including the error, or the pre-processing means 127 may automatically correct the pattern paper data including the error.

For example, the pre-processing means 127 equalizes the number of coordinate points of the received pattern paper data of the plurality of pieces of clothing. The pre-processing means 127 may add coordinate points to at least one piece of pattern paper data among the pieces of pattern paper data of the plurality of pieces of clothing to make the number of coordinate points of the pieces of pattern paper data of the plurality of pieces of clothing uniform. Alternatively, the pre-processing means 127 may newly add a coordinate point to each of the pieces of pattern paper data of the plurality of pieces of clothing and reexpress the pieces of pattern paper data of the plurality of pieces of clothing with vector data, thereby equalizing the number of coordinate points of the pieces of pattern paper data of the plurality of pieces of clothing. It is preferable to have a consistent number of coordinate points in the pattern paper data of a plurality of pieces of clothing from the viewpoint of being able to efficiently perform learning and to ensure the accuracy of the generated trained model.

In a case where a coordinate point is newly added to each of the pattern paper data of the plurality of pieces of clothing and the pattern paper data is expressed again by vector data, the pre-processing means 127 first generates the same number of landmarks in each of the pattern paper data of the plurality of pieces of clothing. The landmark is generated at a place where the curvature is larger than that of the surroundings, a place where the number of line segments connected to a point such as a T junction is two or more, or the like. Furthermore, positions of the button, the button-hole, and the like are also regarded as landmarks. In order to generate a consistent number of landmarks in the pattern paper data of different sizes, the pre-processing means 127 first generates landmarks by regarding a portion where a bend angle of a curve exceeds a certain angle threshold such as 25 degrees as a “corner” in a master size (for example, a standard size such as M), and sets the generated number of landmarks to L. For the size other than the master size, the bending angle is obtained for each point of bending of the curve, and the top L points with large bending angles can be regarded as landmarks. The landmarks may be regarded as feature points that capture features of the shape of the pattern paper. The landmarks can be utilized, for example, when measuring dimensions.

After the landmarks are created, coordinate points are added between the landmarks as necessary. The added coordinate points may represent, for example, vertices that define the shape of the curve between the landmarks. The number of coordinate points added between the landmarks is the same in each of the pattern paper data of the plurality of pieces of clothing. Alternatively, a control point of the parametric curve may be added in addition to the coordinate point or instead of the coordinate point. The control points of the parametric curve result in the curve between the landmarks being represented by the parametric curve. In this case, the order of the parametric curve is preferably the same in each of the plurality of pieces of pattern paper data.

Next, information of coordinate points of each of the pieces of pattern paper data of the plurality of pieces of clothing is aggregated into the corresponding extended vertices. As a result, one extended vertex has the information of the corresponding coordinate point in each of the plurality of pieces of pattern paper data. For example, when one coordinate point has two-dimensional information, the extended vertex in which information of 5 sizes is aggregated has 10 dimensional information. For example, the information on the corresponding landmarks in the plurality of pieces of pattern paper data can be aggregated into one corresponding extended vertex, and the information on the coordinate points between the corresponding landmarks in the plurality of pieces of pattern paper data can be aggregated into one corresponding extended vertex. Since the plurality of pieces of pattern paper data have the same topology (the number of coordinate points and the manner of connection between the coordinate points), it is not necessary to have the connection information between the coordinate points in all the plurality of pieces of pattern paper data as long as it has the connection information between the coordinate points in one piece of pattern paper data among the plurality of pieces of pattern paper data.

FIG. 5B is a diagram illustrating a concept of aggregating information of a landmark and a coordinate point (normal vertex) between the landmarks into each corresponding extended vertex. Hollow circles represent landmarks and solid circles represent normal vertices.

In the plurality of pieces of pattern paper data, corresponding landmarks, for example, landmarks defining the upper left corner, are aggregated into one extended vertex 501, and corresponding normal vertexes, for example, vertexes adjacent to the landmarks defining the upper left corner, are aggregated into one extended vertex 502.

Since the plurality of pieces of pattern paper data have the same topology, coordinate points aggregated at the same extended vertex can be treated as having the same connection mode. Therefore, for example, as long as the connection information between the coordinate points in the standard size pattern paper data is included, the connection information can be applied to the relationship between the coordinate points in the pattern paper data of another size. Therefore, it is not necessary to include the connection information between the coordinate points in the pattern paper data of another size. As a result, the required storage amount can be reduced.

The pre-processing means 127 detects, for example, components in the received pattern paper data of a plurality of pieces of clothing. The component includes at least one of a button, a button-hole, a loop, a tack, a dart, or a pleat. For example, the pre-processing means 127 may detect a component from information included in the pattern paper data, or may detect a component by pattern matching. For example, since there are various types and sizes of buttons, it is preferable to prepare patterns for pattern matching so as to be compatible with buttons of various types and sizes.

The pre-processing means 127 can add a virtual component (phantom) to at least one of the pieces of pattern paper data of the plurality of pieces of clothing so as to equalize the number of components in each of the pieces of pattern paper data of the plurality of pieces of clothing for the component whose number varies depending on the size among the detected components. It is preferable to align the number of components, the number of which may vary according to the size in each of the pieces of pattern paper data of the plurality of pieces of clothing from the viewpoint of being able to efficiently perform learning and to ensure the accuracy of the generated trained model. The pre-processing means 127 divides the components into groups based on, for example, the size of the detected component or the like. It is considered that the number of components having the same size and disposed at equal intervals on the pattern paper data is highly likely to change depending on the size. After the components are detected for all the pieces of pattern paper data of the plurality of clothing, the minimum value and the maximum value of the number of each component are recorded for each group, and in a case where there is a difference between the minimum value and the maximum value of the number, it is confirmed whether the components are disposed at equal intervals in each pattern paper, and in a case where there is such a difference, the components can be regarded as components whose number varies depending on the size of the clothing. For example, the pre-processing means 127 generates a virtual component and adds the virtual component to the pattern paper data so that the number of components of other pattern paper data is matched with the number of components of the pattern paper data having the largest number of components regarded as components whose number varies depending on the size of the clothing among the pieces of pattern paper data of the plurality of pieces of clothing.

For example, it is assumed that the maximum value of the number of buttons in the plurality of pieces of pattern paper data is eight, and the number of buttons included in certain pattern paper data is six. In this case, 8−6=2 phantoms (virtual buttons) are generated in the pattern paper data. In this way, the number of buttons included in each piece of pattern paper data can be forcibly unified to eight, and the topology of all pieces of pattern paper data can be made the same. By performing similar processing on button-holes, loops, and the like other than the buttons, the respective numbers can be made uniform.

For example, in a case where a seam allowance is included in a plurality of pieces of received pattern paper data, the pre-processing means 127 can delete the seam allowance. As a result, the pattern paper data of the plurality of pieces of pretreated clothing does not include the seam allowance. The seam allowance is not a smooth curve, but may have a distorted shape, which is highly likely to cause a problem in learning. Therefore, by removing the seam allowance, the possibility of successful learning can be improved.

The pre-processed pattern paper data is passed to the learning means 128.

The learning means 128 is configured to learn a relationship between the pieces of pattern paper data of the plurality of pieces of clothing pre-processed by the pre-processing means 127. The learning means 128 can learn at least a coordinate point (For example, a coordinate point of a landmark, a coordinate point between landmarks, and a control point of parametric curve between landmarks.) included in the pattern paper data as a feature amount. Preferably, the learning means 128 can learn the coordinate points included in the pattern paper data and the number of components included in the pattern paper data as feature amounts, and learns the relationship between the coordinate points of the pattern paper data of the plurality of pieces of clothing as well as the relationship between the number of components included in the pattern paper data of the plurality of pieces of clothing. More preferably, the learning means 128 can learn the coordinate points included in the pattern paper data and the number of components and/or the dimension of each part included in the pattern paper data as feature amounts, and learns the relationship between the number of components included in the pattern paper data of the plurality of pieces of clothing and/or the relationship between the dimensions of the pattern paper data of the plurality of pieces of clothing together with the relationship between the coordinate points of the pattern paper data of the plurality of pieces of clothing.

The learning means 128 can perform unsupervised learning. The learning means 128 can use, for example, a Gaussian Process Latent Variable Model (GPLVM), or can use Auto Encoder or another method capable of learning a relationship between learning data. Since the learning means 128 uses the vector data instead of the image data as the learning data, problems specific to the image data such as blurring of the contour or rounding of sharp corners do not occur. Furthermore, processing of conversion/inverse conversion between the image data and the vector data is also unnecessary.

In a case where the GPLVM is used, a manifold is formed in the latent space as illustrated in FIG. 5A by learning by the learning means 128. Any point in the latent space will represent the corresponding pattern paper data. By using the plurality of pieces of pattern paper data used for learning as the pattern paper data of the clothing that can be manufactured, the generated manifold can be a set of points representing the pattern paper data of the clothing that can be manufactured. Furthermore, since the number of coordinate points in the pattern paper data used for learning is uniform, more points in the generated manifold can represent the pattern paper data of the clothing that can be manufactured. Moreover, since the number of components in the pattern paper data used for learning is uniform, even in a case where there are components whose number varies depending on the size, it can be used for learning, and more points in the generated manifold can be points representing the pattern paper data of clothing that can be manufactured.

The system 100 may include the configuration of the processor unit 120A instead of the processor unit 120, may include the configuration of the processor unit 120B instead of the processor unit 120, may include the configuration of the processor unit 120B in addition to the configuration of the processor unit 120, or may include the configuration of the processor unit 120B in addition to the configuration of the processor unit 120A. In a case where the configuration of the processor unit 120B is included in addition to the configuration of the processor unit 120, or in a case where the configuration of the processor unit 120B is included in addition to the configuration of the processor unit 120A, the system 100 may include a single processor unit that implements these configurations, or may include a plurality of processor units that collectively implements these configurations.

The trained model generated by the processor unit 120B may be used by the processor unit 120 or the processor unit 120A, or may be used in another system. For example, when the processor unit 120 or the processor unit 120A utilizes a trained model generated by learning pattern paper data of clothing having the same topology as a specific clothing and a plurality of clothing having different sizes and/or shapes, the system 100 may be a clothing creation system capable of creating new clothing.

In the clothing creation system, the reception means 121 can receive the size information, the generation means 122 generates the pattern paper data of the clothing having a size suitable for the size indicated by the size information using the trained model, and the output means 123 outputs the generated pattern paper data. Here, the generated pattern paper data is the pattern paper data of the clothing having the same topology as a specific clothing and having a size suitable for the size indicated by the size information. For example, it is possible to create pattern paper data of new clothing having the same topology by using a trained model obtained by learning pattern paper data of pants having the same topology for a specific pants. For example, it is possible to create pattern paper data of new pieces of clothing having the same topology by using a trained model obtained by learning pattern paper data of a shirt having the same topology for a specific shirt. Since the created pattern paper data is created by a trained model having undergone learning by unsupervised learning, the clothing created by this pattern paper data is expected to be novel and outrageous clothing beyond the designer's idea.

The above-described grading system 100 may constitute a clothing manufacturing system together with, for example, means for manufacturing clothing based on the output pattern paper data. The means for manufacturing the clothing may be any means as long as the clothing can be manufactured using the pattern paper data, and may be, for example, a machine provided in a clothing manufacturing factory.

Note that each configuration element of the system 100 described above may be configured by a single hardware component or may be configured by a plurality of hardware components. In a case where the configuration includes a plurality of hardware components, a mode in which each hardware component is connected is not limited. The hardware components may be connected wirelessly or by wire. The system 100 of the present invention is not limited to a specific hardware configuration. It is also within the scope of the present invention that the processor units 120, 120A, and 120B are configured by analog circuits instead of digital circuits. The configuration of the system 100 of the present invention is not limited to that described above as long as the function can be realized.

### 4. Processing by System for Grading

FIG. 6A is a flow chart illustrating an example of a process for grading (process 600) by the system 100 for grading. The process 600 may be performed at the processor unit 120 or the processor unit 120A of the system 100. Although it will be described below that the process 600 is executed in the processor unit 120, it is understood that the process is similarly executed in the processor unit 120A.

In step S601, the reception means 121 of the processor unit 120 receives the clothing identification information for identifying the target clothing and the size information. The clothing identification information may be any information as long as the target clothing can be identified, and for example, the clothing identification information may be information indicating a type of clothing (for example, a model number, a product number, a mode type, a model, and the like.). For example, the clothing identification information may be image data of the target clothing or pattern paper data of the target clothing.

In step S602, based on the clothing identification information and the size information received in step S601, the generation means 122 of the processor unit 120 generates the pattern paper data of the clothing of the same type as the target clothing and having a size suitable for the size indicated by the size information. The generation means 122 can generate the pattern paper data of the clothing of the same type as the target clothing using the trained model. The trained model learns a relationship between a plurality of pieces of pattern paper data of the clothing of the same type as the target clothing.

In a case where the target clothing includes components the number of which varies according to the size, the generation means 122 can delete one or more of a plurality of components from the pattern paper data output from the trained model according to the size indicated by the size information. As a result, it is possible to allow the pattern paper data of the size to include the number of components that should originally be included.

Since the pattern paper data output from the trained model does not include a seam allowance, the generation means 122 can add the seam allowance to the pattern paper data output from the trained model. As a result, pattern paper data of clothing that can be actually manufactured and has a seam allowance can be generated.

In step S603, the output means 123 of the processor unit 120 outputs the pattern paper data generated in step S602.

The output means 123 can output the generated pattern paper data to the outside of the system 100 via the interface unit 110. The output means 123 can output the generated pattern paper data to the database unit 200 via the interface unit 110, for example. The output means 123 can output the generated pattern paper data to the terminal device 300 via the interface unit 110, for example.

The pattern paper data output by the process 600 can be used for any purpose. For example, as described above with reference to FIG. 1A, it may be provided to the manufacturer M and utilized to manufacture clothing purchased by the user U. For example, as described above with reference to FIG. 1B, it may be provided to the user U and utilized to manufacture clothing having a variety of sizes. Alternatively, it can be utilized to manufacture clothing in a clothing manufacturing system comprising the system 100 and means for manufacturing clothing based on the output pattern paper data.

FIG. 6B is a flow chart illustrating another example of a process for grading (process 610) by the system 100 for grading. The process 610 may be performed in the processor unit 120A of the system 100.

Step S611 is a step similar to step S601, and in step S611, the reception means 121 of the processor unit 120A receives the clothing identification information for identifying the target clothing and the size information.

Step S612 is a step similar to step S602, and in step S612, the generation means 122 of the processor unit 120A generates the pattern paper data of the clothing of the same type as the target clothing and having a size suitable for the size indicated by the size information based on the clothing identification information and the size information received in step S611.

In step S613, the calculation means 124 of the processor unit 120A calculates the reliability of the pattern paper data generated in step S612. For example, the calculation means 124 can calculate the reliability based on the position of the generated pattern paper data in the latent space. For example, when the trained model also learns the reliability of a plurality of pieces of pattern paper data, the calculation means 124 can calculate the reliability based on the output from the trained model.

In step S614, it is determined whether the reliability calculated in step S613 is lower than a predetermined threshold. The predetermined threshold may be any threshold value, and may be, for example, a threshold value for classifying whether or not it is pattern paper data of clothing that can be manufactured. That is, the predetermined threshold can be regarded as data that can be manufactured when the reliability is equal to or greater than the predetermined threshold value, and can be regarded as not data that can be manufactured when the reliability is lower than the predetermined threshold value.

In a case where the reliability is lower than the predetermined threshold (Yes branch), the process proceeds to step S615, and in a case where the reliability is greater than or equal to the predetermined threshold (No branch), the process proceeds to step S616.

In step S615, the output means 123 of the processor unit 120A executes a given action. In one example, the output means 123 may not output the pattern paper data generated in step S613. As a result, it is possible to prevent the low reliability pattern paper data from being provided to the user. In another example, the output means 123 can output a notification. The notification may be, for example, a notification indicating that the reliability of the generated pattern paper data is low, or a notification for confirming to the user that the pattern paper data is output even though the reliability of the generated pattern paper data is low. Alternatively, the notification may be a notification indicating that the pattern paper data is not output because the reliability of the generated pattern paper data is low. As a result, it is possible to notify the user or the administrator of the system 100 that the reliability of the generated pattern paper data is low, and encourage the user or the administrator to take measures to improve the reliability. The measure includes, for example, creation and learning of new learning data corresponding to the pattern paper data, or modification of existing learning data. For example, creation of new learning data and correction of existing learning data are performed by a patterned or grader, and the created new learning data and the corrected existing learning data can be highly reliable pattern paper data. The learning means 125 of the processor unit 120A learns the created new learning data and the corrected existing learning data.

Step S616 is a step similar to step S603, and the output means 123 of the processor unit 120A outputs the pattern paper data generated in step S602.

By the process 610, it is possible to ensure that only the pattern paper data whose reliability is greater than or equal to the predetermined threshold is output. Furthermore, by prompting the creation or correction of the learning data with respect to the pattern paper data having the reliability lower than the predetermined threshold, it is also possible to prompt the creation of a more accurate trained model.

FIG. 7 is a flowchart illustrating another example of a process (process 700) for generating a trained model by the system 100 for grading. The process 700 may be performed in the processor unit 120B of the system 100.

In step S701, the reception means 126 of the processor unit 120B receives pieces of pattern paper data of the plurality of pieces of clothing. These pieces of pattern paper data are learning data. Each of the pieces of pattern paper data of the plurality of pieces of clothing can be expressed by a plurality of coordinate points. The pieces of pattern paper data of the plurality of pieces of clothing are particularly preferably the pieces of pattern paper data of the pieces of clothing that can be manufactured.

The plurality of pieces of clothing can have components whose number varies depending on the size, and in this case, the pieces of pattern paper data of the plurality of pieces of clothing also has coordinate points of the components whose number varies depending on the size. The pieces of pattern paper data of the plurality of pieces of clothing can also include dimensions of each part.

In one example, the pieces of pattern paper data of the plurality of pieces of clothing may be pieces of pattern paper data of the pieces of clothing that are the clothing of the same type as the specific clothing and have different sizes. As a result, the trained model generated by the process 700 can generate the pieces of pattern paper data of the pieces of clothing of the same type as the specific clothing and having a size suitable for the specific size, and thus can be used for grading of the specific clothing.

In another example, pieces of pattern paper data for a plurality of pieces of clothing may be pieces of pattern paper data for pieces of clothing that each have the same topology as a particular clothing and have different sizes and/or shapes. As a result, the trained model generated by the process 700 can generate the pattern paper data of the clothing having a size and/or shape different from that of the specific clothing, and thus is available for creation of new clothing.

In step S702, the pre processing means 127 of the processor unit 120B pre-processes the pieces of pattern paper data of the plurality of pieces of clothing received in step S702. The pre-processing is performed, for example, to reduce errors in learning and/or to enable learning to be performed efficiently.

The pre-processing includes, for example, at least one of inspecting whether there is a zigzag shape in the outline of the pieces of pattern paper data of the plurality of pieces of clothing, aligning the number of coordinate points of the pieces of pattern paper data of the plurality of pieces of clothing, detecting components in the pieces of pattern paper data of the plurality of pieces of clothing and aligning the number of components in each of the pieces of pattern paper data of the plurality of pieces of clothing, and deleting a seam allowance included in the pieces of pattern paper data of the plurality of pieces of clothing. Preferably, the pre-processing includes aligning the number of coordinate points of the pieces of pattern paper data of the plurality of pieces of clothing. More preferably, the pre processing further includes detecting components in the pieces of pattern paper data of the plurality of pieces of clothing and aligning the number of components in each of the pieces of pattern paper data of the plurality of pieces of clothing. This is because by aligning the number of coordinate points and the number of components, learning can be made efficient, and the accuracy of the generated trained model can also be guaranteed.

In step S703, the learning means 128 of the processor unit 120B learns a relationship between the pieces of pattern paper data of the plurality of pieces of clothing pre-processed in step S702. The learning means 128 can learn at least a coordinate point included in the pattern paper data as a feature amount. Preferably, the learning means 128 can learn the coordinate points included in the pattern paper data and the number of components included in the pattern paper data as feature amounts, and learns the relationship between the coordinate points of the pattern paper data of the plurality of pieces of clothing as well as the relationship between the number of components included in the pattern paper data of the plurality of pieces of clothing. More preferably, the learning means 128 can learn the coordinate points included in the pattern paper data and the number of components and/or the dimension of each part included in the pattern paper data as feature amounts, and learns the relationship between the number of components included in the pattern paper data of the plurality of pieces of clothing and/or the relationship between the dimensions of the pattern paper data of the plurality of pieces of clothing together with the relationship between the coordinate points of the pattern paper data of the plurality of pieces of clothing.

By using the pieces of pattern paper data of the plurality of pieces of clothing used for learning as the pieces of pattern paper data of the pieces of clothing that can be manufactured, the output from the generated trained model is more likely to be the pieces of pattern paper data of the pieces of clothing that can be manufactured. Furthermore, since the number of coordinate points in the pattern paper data used for learning is uniform, there is a higher possibility that the output from the generated trained model is the pattern paper data of clothing that can be manufactured. Moreover, since the number of components in the pattern paper data used for learning is uniform, even in a case where there is a component whose number varies depending on the size, it can be used for learning, and the output from the generated trained model is more likely to be the pattern paper data of clothing that can be manufactured.

The process 700 may generate a trained model that can be utilized to grade particular clothing or a trained model that can be utilized to create new clothing. The trained model generated by the process 700 may be utilized in the process 600 and the process 610.

In the example described above with reference to FIGS. 6A, 6B, and 7, the processing is performed in a specific order, but the order of each processing is not limited to the described order, and the processing can be performed in any order that is logically possible.

In the example described above with reference to FIGS. 6A, 6B, and 7, it has been described that the processing of each step illustrated in FIG. 6 is realized by the processor unit 120, 120A, or 120B and the program stored in the memory unit 130, but the present invention is not limited thereto. At least one of the processing of each step illustrated in FIGS. 6A, 6B, and 7 may be realized by a hardware configuration such as a control circuit.

The present invention is not limited to the above-described embodiments. It is understood that the invention is to be interpreted only by the claims. It is understood from the description of the specific preferred embodiments of the present invention that a person skilled in the art can implement equivalent ranges based on the description of the present invention and the common general knowledge. For example, it should be understood that features described for one embodiment are also applicable to another embodiment.

### INDUSTRIAL APPLICABILITY

The present invention is useful in that it is possible to provide a system and the like for grading that can easily obtain appropriate pattern paper data.

### DESCRIPTION OF REFERENCE SIGNS

U user
P provider
M manufacturer
100 system
110 interface unit
120, 120A, 120B processor unit
130 memory unit
200 database unit
300 terminal device
400 network

1.-18. (canceled)

19. A system for outputting pattern paper data, the system comprising:
a reception means that receives size information;
a generation means that generates, based on the size information, pattern paper data of clothing having a size suitable for a size indicated by the size information using a trained model, the trained model including a model obtained by learning a relationship between pieces of pattern paper data of a plurality of pieces of clothing of a type same as a specific clothing; and
an output means that outputs the generated pattern paper data.

20. The system according to claim 19, wherein:
the reception means is further configured to receive clothing identification information for identifying target clothing and size information;
the generation means is further configured to generate, based on the clothing identification information and the size information, pattern paper data of clothing of the same type as the target clothing and having a size suitable for a size indicated by the size information using the trained model, the trained model including a model obtained by learning a relationship between pieces of pattern paper data of a plurality of pieces of clothing of the same type as the target clothing.

21. The system according to claim 20, wherein the target clothing and the plurality of pieces of clothing include components whose number varies according to sizes of the target clothing and the plurality of pieces of clothing, and the trained model learns a relationship between the pieces of pattern paper data of the plurality of pieces of clothing by aligning the number of the components in the pieces of pattern paper data of the plurality of pieces of clothing.

22. The system according to claim 21, wherein the generation means is further configured to delete one or more of the components from the generated pattern paper data output from the trained model according to the size indicated by the size information.

23. The system of claim 22, wherein the components include at least one of a button, a button-hole, a loop, a tack, a dart or a pleat.

24. The system according to claim 19, further comprising a calculation means that calculates reliability of the generated pattern paper data,
wherein the output means outputs a notification or does not output the generated pattern paper data in a case where the reliability is lower than a predetermined threshold.

25. The system according to claim 24, further comprising a learning means that causes the trained model to learn pattern paper data of clothing having the size in a case where the reliability is lower than the predetermined threshold.

26. The system according to claim 19, wherein the pieces of pattern paper data of the plurality of pieces of clothing do not include a seam allowance, and
the generation means is configured to add a seam allowance to the generated pattern paper data output from the trained model.

27. The system according to claim 19, wherein the generated pattern paper data is represented using a parametric curve.

28. A clothing manufacturing system comprising:
the system according to claim 19; and
means for manufacturing clothing based on the generated pattern paper data output.

29. The system according to claim 19, wherein the pieces of pattern paper data and the generated pattern paper data are vector data expressing a plurality of coordinate points.

30. The system according to claim 19, wherein the pieces of pattern paper data and the generated pattern paper data include dimensions of each part.

31. The system according to claim 21, wherein the generated pattern paper data includes an estimated value of the number of the components.

32. The system according to claim 26, wherein the generation means is configured to obtain pattern paper data to which the seam allowance is added by:
converting the generated pattern paper data output into an image;
obtaining a signed distance function by an image processing-based method on the image;
specifying a line equidistant outside from an outline of pattern paper in the image to set a region between the outline and the line as a seam allowance; and
converting the image with the seam allowance added into pattern paper data.

33. The system according to claim 19, wherein the trained model is generated with Gaussian Process Latent Variable Model (GPLVM).

34. The system according to claim 24, wherein the trained model forms a latent space, a point in the latent space representing corresponding pattern paper data, each pattern paper data having reliability according to a position in the latent space,
wherein the calculation means calculates the reliability corresponding to a position by specifying the position of the generated pattern paper data in the latent space.

35. The system according to claim 27, wherein the parametric curve is a Bezier curve.

36. The clothing manufacturing system according to claim 28, wherein the means for manufacturing clothing includes a machine for clothing manufacturing, or a cutting machine and a sewing machine.

37. A method for outputting pattern paper data, the method comprising:
receiving size information;
generating, based on the size information, pattern paper data of clothing having a size suitable for a size indicated by the size information using a trained model, the trained model including a model obtained by learning a relationship between pieces of pattern paper data of a plurality of pieces of clothing of a type same as a specific clothing; and
outputting the generated pattern paper data.

38. A non-transitory computer-readable storage medium storing a program for outputting pattern paper data, the program being executed in a computer including a processor, the program causing the processor to perform processing including:
receiving size information;
generating, based on the size information, pattern paper data of clothing having a size suitable for a size indicated by the size information using a trained model, the trained model including a model obtained by learning a relationship between pieces of pattern paper data of a plurality of pieces of clothing of a type same as a specific clothing; and
outputting the generated pattern paper data.
